(19) United States
(12) Patent Application Publication
(10) Pub. No.: US 2008/0003001 A1
(43) Pub. Date: Jan. 3, 2008

(54) Methods for controlling print quality

(76) Inventors: Jouni Marttila, Espoo (FI); Miika Jokinen, Espoo (FI)

Correspondence Address: KUBOVCIK & KUBOVCIK, SUITE 710, 900 17TH STREET NW, WASHINGTON, DC, 20006, US

(21) Appl. No.: 11/808,396

(22) Filed: Jun. 8, 2007

(30) Foreign Application Priority Data
Jun. 9, 2006 (FI) 20065394

(51) Int. Cl. G03G 15/00

(52) U.S. Cl. 399/45

(57) ABSTRACT

The present invention relates to a method of classifying print substrates for printing, to a print process, a method of estimating the print properties of print substrates and a novel use of ink requirement. In the method, a parameter describing the structure of the print substrate is measured and one of a number of print substrate classes is selected for the print substrate at least partly on the basis of the measured structure-describing parameter. According to the invention the parameter describing the structure is ink requirement, which has been found to well describe dot gain. The invention produces an efficient way of classifying paper on the basis of its colour reproduction properties.

### FIELD OF THE INVENTION

The present invention relates to printing technology, especially printing on paper and other similar substrates. The invention relates specially to a method of classifying papers for printing, to a printing process and the quality control of the print result. The invention also relates to a novel use.

### BACKGROUND OF THE INVENTION

Printers strive to produce to the customer print products that meet a predefined quality, such as an ISO standard. One of the most crucial factors having an effect on the quality level is the colour space of the print product, the adjustment of which is called colour management. The used print method and the print parametres chosen for it, the used inks and the properties of the print substrate, such as tone, brightness and structure, among others, have an effect on the colour space of the print product.

Traditionally, test sheets are printed with standardized print processes for measuring and calculating the optimal profiles to be used for printing such sheets. Print houses can, however, have a number of different paper grades in stock, the grades further comprising paper types with different print profiles. Thus, tens of measurement series' are needed for finding out all print profiles. In case different printing machine parametres or different ink qualities (hereinafter “print parameters”) are used at the printers' or they are changed at some point, the profile measurements will have to be repeated with these print parameters. This is time-consuming and expensive. The situation is similar if the print house takes a new paper type in its stock.

Currently, papers are mostly classified for print purposes on the basis of their tone and brightness, as these factors define the white point of the gamut that can be achieved. Another considerable factor for print result and colour reproduction is the surface structure of the paper. The surface structure especially has an effect on the increase of the size of screen dot, which means an increase of the screen dot in print process. Usually, the dot gain is at its largest in midtones, at a tone area of about 30-70%. A downside of dot gain in classifying papers is, however, that the amount of dot gain greatly varies according to print parameters as well. This is because the parameters of the print method and the used inks determine the dot gain. For example, sheet print and newspaper print have very different dot gains. Thus, dot gain is a very multi-dimensional quantity and it is not suitable for use in classifying papers with current methods.

Currently, using dot gain for classifying paper requires very extensive test prints with various print parameters. As the process contains a number of variables, it is difficult to get reliable and standardized information about dot gain. On the other hand, no other methods exist either for classifying papers without extensive test prints using the said paper type and the final print methods and inks. Those working in the branch know that this is expensive. Thus, the current classifying system based on paper type is not preferred for the industry considering exact estimates of the colour space that can be achieved and adjustments to the printing process so as to be optimal for the paper to be used.

### OBJECT OF THE INVENTION

The aim of the invention is to produce a novel method for estimating the printability of a certain substrate, for, e.g., classifying them by means of simple laboratory measurements.

Another aim of the invention is to produce a printing process in which the print substrate is selected in a totally new way.

The invention also aims to produce a new use.

### SUMMARY OF THE INVENTION

The invention is based on the idea that measurement of the ink requirement of the print substrate can produce essential colour management information about the surface structure of the paper, especially about dot gain. We have namely noticed that there is a linear dependency between the ink requirements of a paper and the dot gain which can be used for classifying papers for printing. Thus, extensive print tests for classifying a single paper can be avoided.

Therefore, in the method according to the invention for classifying print substrates the ink requirement of the print substrate is measured and the print substrate is classified at least partly on the basis of ink requirement into one of a number of print substrate classes so that the ink requirements of a print substrate belonging to one class fulfill a pre-defined criterion.

In the print process according to the invention the printed print substrate is selected and ink is applied onto the print substrate by means of the selected printing method. According to the invention the print substrate is selected from a number of print substrates belonging to at least two classes, whereby the classifying of the said print substrates is defined at least partly by measuring their ink requirement, and the print profile of the selected print method is selected at least partly on the basis of the class of the print substrate to be printed.

In the method according to the invention for estimating the print properties of print substrates the effect of the surface structure of the first print substrate on the print result is estimated when using the selected print method and at least one coverage and density level. According to the invention, the effect of the surface structure is estimated by measuring the ink requirement of the first print substrate with said coverage and density level and by comparing the measurement result with the relationship between the ink requirement and dot gain measured by means of at least two other print substrates.

A paper or board batch according to the invention is provided with an indicator including information about at least the tone, brightness and ink requirements of the paper of the batch.

The invention also provides a new use for ink requirement in classifying print substrates.

Especially when the information received from the measurement of the ink requirement of the print substrate is used together with the tone and brightness of the print substrate, both of which can also be measured with laboratory methods, it is possible to formulate a classification for papers according to current standards on the basis of their colour reproduction properties by using only easily measurable colour management criteria.

By paper or board grade we refer to the grading of papers and boards well known in the industry on the basis of the raw materials and coating layers of the papers and boards (LWC, MWC and so on), where there can be a number of different paper and board types within each grade.

More specifically, the method of classifying papers according to the invention is characterized in that the ink requirement of the print substrate is used as the parameter describing the surface structure.

The printing process according to the invention is characterized by a print substrate classification at least partly based on measured ink requirements of print substrates, and selecting the print profile of the selected print method at least partly on the basis of the class of the print substrate to be printed.

The method of estimating the printing properties of print substrates is characterized in that the effect of the surface structure is evaluated by measuring the ink requirement of the first print substrate with said coverage and density level, and by comparing the measurement result with the print method specific relation between the measured ink requirement and dot gain of at least two other print substrates.

A paper or board batch according to the invention is characterized in that it is provided with an indicator containing information about the tone, brightness and ink requirement of the paper or board contained in the batch.

The use according to the invention is characterized by using the ink requirement of a print substrate for classifying print substrates for printing.

A number of advantages are achieved by means of the invention. It offers a method for classifying individual paper types into a print class taking the colour gamut of the final printed product into consideration even without test print runs with the actual print machine. Thus, it simplifies classifying the papers, which further simplifies the decision making of the actors in the print chain, such as paper makers, print houses and publishers. It also improves the quality of print products. The method thus corresponds better than the known systems to the current print quality needs as far as the colour reproduction of paper is concerned. Because the invention also accomplishes avoiding extensive test prints in real print conditions, it also brings about considerable cost savings.

A notable feature of the invention is that it eliminates the need to measure the dot gain for individual papers. It will be sufficient to know the dot gains and ink requirements of two or more reference papers, which can then be used as a basis for estimating the colour reproduction of the paper being examined by only measuring the ink requirement of the paper.

The invention is based on the observation that ink requirement and dot gain have a linear dependence. As ink requirement does not, however, depend on the chosen print method as strongly as the dot gain, the invention offers totally new possibilities for both the paper maker and the paper seller. The paper or board type can be examined by means of the embodiments of the invention and the delivered paper batch can be provided with an indicator containing information about the tone, brightness and ink requirement of the paper. Typically, the ink type with which the measurement was done is also given in conjunction with the ink requirement. Thus the print does not even have to measure the ink requirement, but the paper can be classified for printing on the basis of the information provided by the manufacturer or the seller.

The invention can especially advantageously be used for classifying papers and boards and for offset printing, but the same principle will probably also work with other corresponding substrates, such as fibre substrates, but to some degree also with polymer substrates.

By “classifying” (or “classification”) is meant any measure (or result of one or more such measures), in which the substrate is linked with a certain group of substrates by, for example, entering corresponding class data to data processing means, such as a computer, from which the class data is further retrievable for further use, for example, for the purpose of printing. Such linking may also take place by providing a batch of similar substrates with a visual indicator of its class determined by the method according to the invention.

### BRIEF DESCRIPTION OF THE DRAWINGS

FIGS. 1a to 1d show the dot gain as a function of coverage measured with four different paper types and three different density levels as a graph,

FIG. 2 shows as a graph the estimated dependency of dot gain to ink requirement on different density levels based on the graphs 1a-1d,

FIG. 3 shows the dot gain as a function of ink requirement on density level 1.4.

FIG. 4 shows the carrying out of a classification method according to one embodiment as a flow chart, and

FIG. 5 shows the flow of a print process according to one embodiment as a flow chart.

### DETAILED DESCRIPTION OF THE INVENTION

In the following, the embodiments of the invention are described in more detail with reference to the appended drawings.

The connection between dot gain and the ink requirement can be found out with test prints. In a test print, at least two reference print substrates are first selected. The dot gain of the substrates is measured with the selected print method, preferably on several density levels and at least one coverage. Subsequent to this also the ink requirement at said density levels is determined. When the connection between dot gain and ink requirement at these density levels is determined, a line can be arranged into the result and the supposed dot gain can further be interpolated or extrapolated for any substrate by means of the measured ink requirement. The slope ratio of the line depends on the used print method and its parameters, whereby it must be separately determined in each print unit or, at the least separately for each print machine type.

Ink requirement also depends on the absorption of the paper and on the roughness of the paper. For coated papers, roughness is the dominant property and for uncoated papers, absorption is the dominant property, although both properties have an influence on the ink requirement.

Print houses can especially utilise an embodiment of the invention in which, subsequent to the measurement of the ink requirement of the print substrate under examination, the ink requirement is compared to the ink requirement of a reference print substrate, whereby the substrate under examination can easily be classified on the basis of ink requirement into the same or a different dot gain class as the reference print substrate.

In addition to ink requirement, the final classification for printing usually also utilizes the tone and brightness of the paper. These three colour management criteria have been found to be sufficient for describing the colour space that can be achieved when printing the paper. Typical for the classification obtained is, that substrates belonging to one print class can be printed with the same print profile and print parametres regardless of their type and grade so that the gamut of the corresponding printed products is sufficiently homogenous. The sufficient homogeneity depends on the use of printed products, but some usable colour management criteria tolerances will be described later.

The dependency between the ink requirement and the dot gain has been found to be most linear between various paper types of one paper grade. Thus, the present method is at its most accurate when the reference print substrate or substrates and the examined print substrate are of the same paper grade.

The print substrate classification may be formed, for example, so that the difference between ink requirements of print substrates belonging to one group is smaller than a pre-defined value. Typically this value is smaller than or equal to about 0,1-0,4 g/m², preferably smaller than or equal to about 0,2 g/m². The ink type and the desired quality level define the final classification.

A suitable criterion for the print method in question and for the desired quality level can be determined on the basis of the connection between dot gain and ink requirement. According to a preferred embodiment the ink requirement difference of print substrates belonging to one print substrate class is smaller than the ink requirement difference leading with the selected print method and selected print parameters to a difference in dot gain of about 3 percentage units or more.

In addition to ink requirement differences, the tone and brightness differences of print substrates belonging to one class also preferably fulfill pre-defined criteria. The brightness and tone of the paper are typically described by means of L*a*b* values of the paper. The tolerances of the tone and brightness of the paper can be classified according to the intended use of the classification. Below are two exemplary tone and brightness classifications. A more stringent tolerance can be used when the customer prefers print quality over workflow (a quality-conscious printer) and a more loose tolerance can be used when workflow is more essential than quality (cost-conscious printer).

The values are measured according to ISO standard 12647-1.2.2004 using a D50 light source, 2° observer angle and 45/0 measurement geometry. In the measurement was used a white background with L*>92 and C*<3. The measurement differs from the common paper industry method of measuring paper tone, but it is widely used in graphic industry.

| | |
|---|---|
| A more loose tolerance: | |
| 1. Copy papers: | L* > 94, b* < −5 |
| 2. WFC, MWC, Hi-brite LWC's: | L* 92-96, b* 0-−5 |
| 3. LWC's, SC's: | L* 87-92, b* 0-5 |
| 4. INP: | L* < 87, b* >3 |
| A more stringent tolerance: | |
| 1. Copy papers: | L* >94, b* < −5 |
| 2. WFC, MWC: | L* 93-96, b* −2-−5 |
| 3. Hi-brite LWC's: | L* 90-93, b* 0-−2 |
| 4. LWC's, SC's: | L* 87-92, b* 0-5 |
| 5. INP: | L* < 87, b* > 3 |

The ink requirement of a print substrate can be measured by means of a small test apparatus that does not have to be the print machine for which the classification is performed. For example, a number of test printing machines are suitable for this purpose.

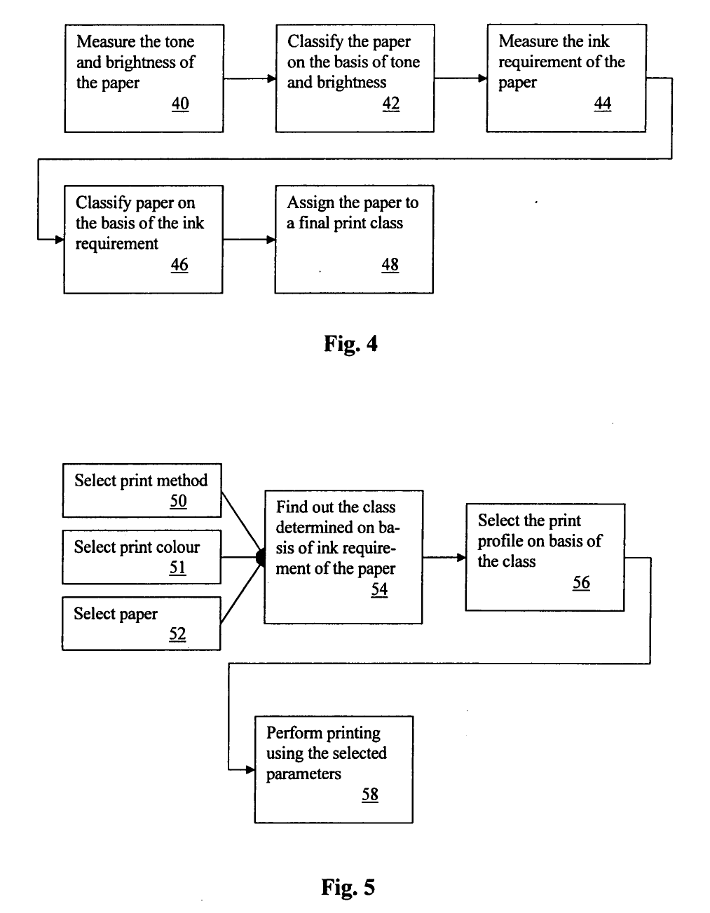

FIG. 4 is an exemplary illustration of the flow of classification. The tone and brightness of the paper are measured in closely controlled conditions at stage 40. At stage 42, the paper is assigned to a tone and brightness class, for example, by using either of the classifications assigned above. Ink requirement is measured at stage 44. At stage 46 the paper is further classified by ink requirement or by dot gain estimated on the basis of it. The tone and brightness and the ink requirement classes are combined at stage 48, whereby the paper is assigned its final print class. Typically, new subclasses are formed within tone and brightness classes on the basis of ink requirement, but the classification can also be made in another way. The number of final classes can be, for example, 4-15.

In order to achieve a more accurate classification and thus to assure a better print quality, the classification can take into consideration the effect of paper and board grade to the connection between ink requirement and dot gain.

When compared with the previous practice the invention provides the important advantage that the number of classes in print substrate classification is smaller than the number of available print substrate types. Thus, it is not necessary to determine a dedicated print profile to each print substrate type, but the same profile can be used for printing on a number of substrates without essentially decreasing print quality.

When the print substrate is classified on the basis of ink requirement and possibly tone and brightness for a certain print method, the class information can further be used in a print process utilizing this method. A dedicated print profile (such as an ICC profile and/or other print parameters) relating to colour management can be assigned to each class for use with substrates belonging to this class. Most preferably, the print profile is selected only on the basis of the class of the substrate to be printed.

FIG. 5 illustrates an exemplary printing process. First, the print method, ink and paper are selected in stages 50, 51 and 52, respectively. After this, in stage 54, the class assigned to the paper on the basis of ink requirement is determined. The classification can be made in advance, but in case the customer, for example, brings their own paper to the print or a new paper type is being commissioned, according to the invention the classification can be made at this step as well. In stage 56 the class information is used for adjusting the print profile of the print machine to suit the paper considering colour management. The printing is carried out at stage 58.

Previously, commissioning a new type of paper in a print house has required extensive test print runs in order to find a print profile suitable for substrate. By means of the inventive method, new paper types, even new paper grades can easily be commissioned in the print. First, the ink requirement of the print substrate are measured, and in case not previously known, the tone and brightness are also determined, subsequent to which the paper is assigned a certain print class at least partly based on the measured ink requirement. After this, this print substrate can be printed on using the print profile already assigned to its class.

The present invention is most suitable for the use of printing presses and other industrial scale high-volume presses, in particular off-set printing, and paper grades used in those purposes (other than ink-jet printing and laser printing generally used in small-scale businesses and at home).

The following is an example of determining the connection between ink requirement and dot gain and, further, the way it is utilized in the print.

### EXAMPLE 1

For printing, dot gain is considered the most important of the quantities describing the structure of the paper. The following test sequence shows that dot gain has a clear connection to the thickness of the ink layer and thus to the ink requirement. The results are from a test run, in which the dot size was measured with various papers and it was compared with the ink requirements of papers.

The test was performed with offset printing as the print method, with an Albert Frankenthal A101A heatset print machine using SUN Chemical Challenge print ink series.

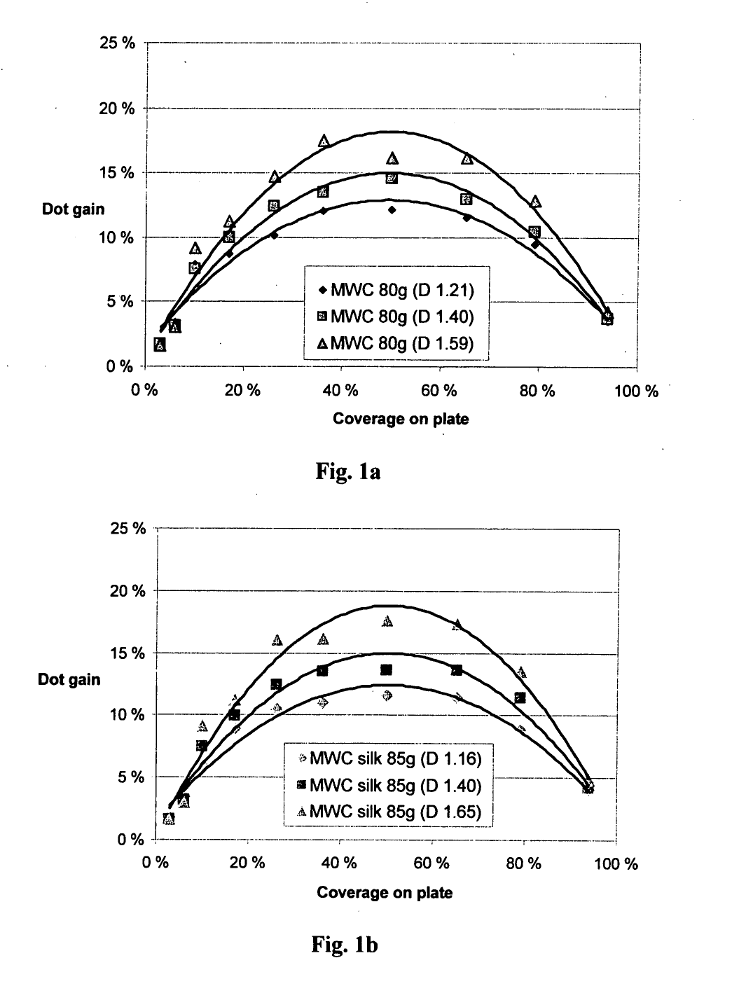

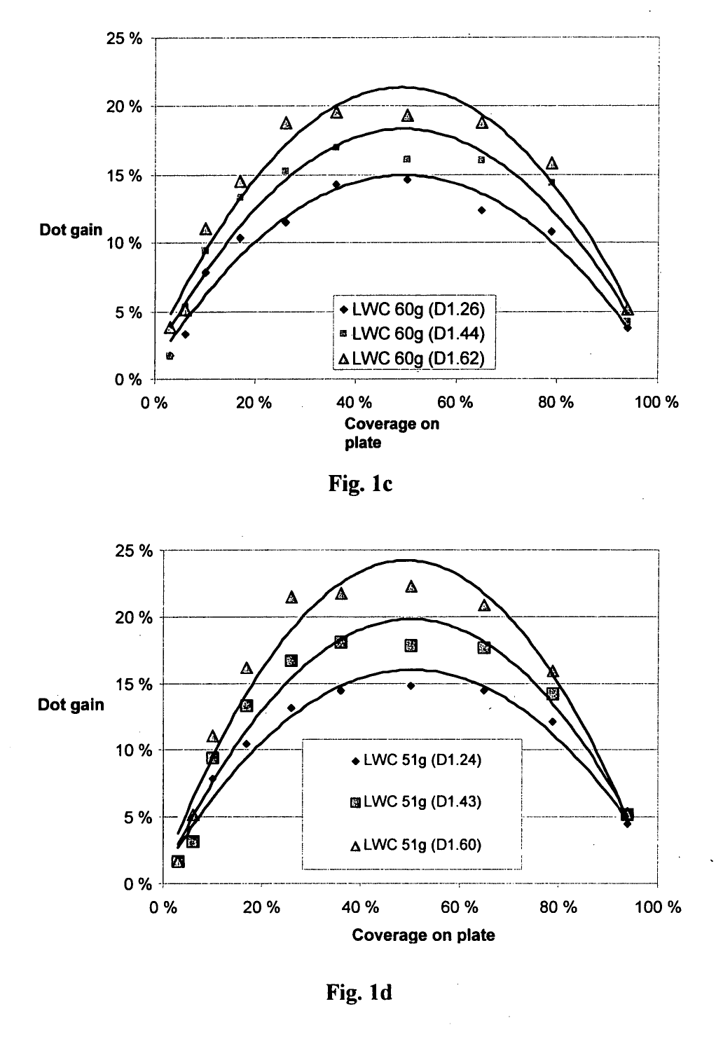

FIGS. 1a-1d show the measured dot gains of two different LWC papers (Light Weight Coated, wood-containing, lightly coated paper) and two different MWC papers (Medium Weight Coated, wood-containing paper with a medium-weight coating) as a function of the dot coverage level of the plate. The measurements were made at three different density levels, because as can be seen from the figures, the selected ink density has a considerable effect on dot gain.

The dot gain curve is rarely totally symmetrical because of a number of factors having an effect on the machine and screening. In this case, a polynomial adaptation was made to the data and the dot gain at the top (50%) was taken as the examined quantity. The adaptation curves are also drawn in the graphs.

Ink requirements of the same papers were also measured as a laboratory measurements using the IGT test print machine. Each paper was printed with five different ink amounts and the ink requirement curve was interpolated on the basis of the results using the Tollenaar-Ernst equation:
D=D_{∝}(1−e^{-my}),
wherein
D=density
D∝=saturated density
y=thickness of ink film, i.e. ink requirement
m=regression coefficient, dependent on the paper and print conditions.

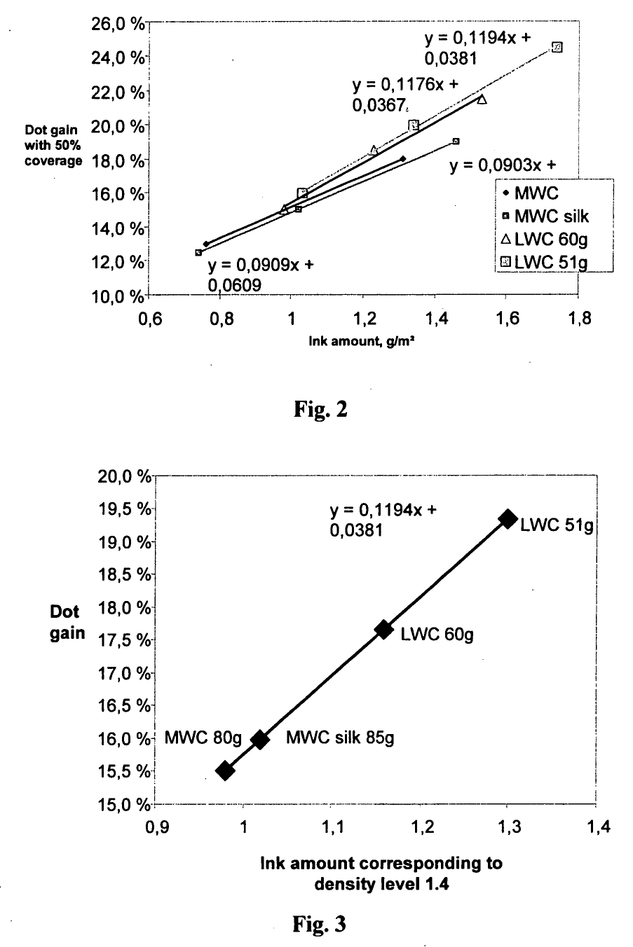

Thus the amount of ink (g/m²), i.e. the thickness of ink layer at each density level could be determined, whereby it was possible to compare the connection between amount of ink and dot gain. FIG. 2 thus illustrates the connection between amount of ink and dot gain. It can be seen that the dependency is linear with a good accuracy.

However, the results also reveal that with two MWC papers (two coating layers) the slope ratio is slightly different from that of the LWC papers (one coating layer). The inference of this is that with papers of different types other quantities besides ink requirement have a slight effect on dot gain. The print method and the conditions of the print machine also have effect on the slope, whereby it is impossible to determine a universal slope. The above-mentioned classification method is therefore dependent on, in addition to print technology, typically, to some degree, of the print parameters.

By means of the observations of FIG. 2, the amount of ink needed for achieving density level 1.4 was calculated. The results are drawn in FIG. 3. Thus, the line of FIG. 3 shows the connection between the ink requirement and the dot gain at density level 1.4.

In printing, 3 percentage units is concerned a significant limit for dot gain difference. This corresponds with the paper types 1 and 3 of ISO standard 12647-2. Thus, FIG. 3 shows, or from the slope ratio of the line can be calculated, that a difference of 3 percentage points in dot gain requires an ink requirement difference of about 0.2 g/m².

In practice this means that the paper being examined can be compared with, for example, the reference paper of the printer and it is possible to find out without test prints whether the papers can be classified into the same dot gain class.

This application claims priority of Finnish patent application No. 20065394 filed Jun. 9, 2006, which is incorporated herein by reference.

We claim:

1. A method of classifying print substrates for printing, in which
a parameter describing the surface structure of the print substrate is measured, and
one of a number of print substrate classes is selected for the print substrate at least partly on the basis of the said parameter describing the surface structure,
characterized in that
ink requirement of the print substrate is used as the parameter describing the surface structure.

2. A method according to claim 1, characterized in that the connection between the measured dot gain and ink requirement with a certain print method when using print substrates other than said print substrate is used for selecting the print substrate class of the print substrate.

3. A method according to claim 1, characterized in that the print substrate class of the print substrate is selected such that the difference in ink requirements of the print substrate and any other print substrate belonging to the same class is smaller than the ink requirement difference leading with the selected print method and selected print parameters to a difference of 3 percentage points or more in dot gain.

4. A method according to claim 1, characterized in that the print substrate class of the print substrate is selected such that the difference in ink requirements of the print substrate and any other print substrate of the same class is smaller than a pre-defined value, typically smaller than about 0.1-0.4 g/m², preferably smaller than or equal to about 0.2 g/m².

5. A method according to claim 1, characterized in that the print substrate class of the print substrate is additionally selected on the basis of tone and brightness such that the difference of tone and brightness values between the print substrate and any other print substrate of the same class fulfills a certain criterion.

6. A method according to claim 1, characterized in that the print substrate is paper or board.

7. A method according to claim 1, characterized in that
a reference print substrate having a known ink requirement, tone and brightness is selected,
a print substrate to be examined is selected, the tone and brightness of which are known or are measured,
the ink requirement of the examined print substrate is measured,
the examined print substrate is classified in the same class with the reference print substrate, if their ink requirement, tone and brightness differences fulfill the pre-defined criteria.

8. A method according to claim 1, characterized in that the ink requirement of the print substrate is measured with an apparatus different from the apparatus used for classifying for printing, typically with a test print machine or other corresponding laboratory apparatus.

9. A print process, in which
the print substrate to be printed on is selected from print substrates classified according to their print properties, and
print ink is applied to the print substrate with the selected print method,
characterized in that
a print substrate classification at least partly based on measured ink requirements of print substrates is used, and
the print profile of the selected print method is selected at least partly on the basis of the class of the print substrate to be printed.

10. A print process according to claim 9, characterized in that a print substrate classification formed additionally on the basis of the tone and brightness of the print substrates is used.

11. A print process according to claim 9, characterized in that the print profile of the selected print method is selected only on the basis of the class of the selected print substrate to be printed on.

12. A print process according to any of claim 9, characterized in that
a print substrate to be examined is taken,
the ink requirement of the examined print substrate is measured,
the examined print substrate is classified into one of a number of classes at least partly on the basis of measured ink requirement,
the printing is performed using the examined print substrate as print substrate and the print profile pre-defined for the class.

13. A print process according to claim 9, characterized in that the classification of print substrates is based on the connection between ink requirement and dot gain measured from at least two different print substrates.

14. A print process according to claim 9, characterized in that the print substrate is paper or board.

15. A print process according to claim 14, characterized in that in said classification of print substrates, the effect of paper or board grade on the connection between ink requirement and dot gain is taken into consideration.

16. A print process according to claim 9, characterized in that in the said classification two print substrates having a difference of at least about 0.1-0.4 g/m², preferably at least about 0.2 g/m² in measured ink requirements belong to different classes.

17. A print process according to claim 9, characterized in that one print machine print profile corresponds to each class of the print substrate classification.

18. A print process according to claim 9, characterized in that the print substrate to be printed on is selected from a group having more grade groups than there are classes in the print substrate classification.

19. A method of evaluating the printing properties of print substrates, in which method the effect of the surface structure of a first print substrate on the print result is evaluated using a selected print method and at least one coverage and density level, characterized in that the effect of the surface structure is evaluated
by measuring the ink requirement of the first print substrate with said coverage and density level, and
by comparing the measurement result with the print method specific relation between the measured ink requirement and dot gain of at least two other print substrates.

20. A method according to claim 19, characterized in that the first print substrate is classified into one of a plurality of print substrate classes at least partly on the basis of the said comparison.

21. A batch of paper or board, characterized in that it is provided with an indicator containing information about the tone, brightness and ink requirement of the paper or board contained in the batch.

22. A method of classifying print substrates for printing comprising measuring an ink requirement of a print substrate and classifying the print substrate based on the ink requirement.

23. The method according to claim 22, further comprising measuring tone and brightness of the print substrate and classifying the print substrate additionally based on tone and brightness.
